(19) United States
(12) Patent Application Publication
(10) Pub. No.: US 2003/0208605 A1
(43) Pub. Date: Nov. 6, 2003

(54) System and method of communication between java components in different namespaces

(76) Inventor: Victor N. Vu, Oceanside, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/137,951

(22) Filed: May 3, 2002

(51) Int. Cl. G06F 15/16

(52) U.S. Cl. 709/227

(57) ABSTRACT

Generally, the system includes a communication channel for providing the communication session, and a communication channel manager for establishing, terminating, and reestablishing the communication session. Generally, the method includes establishing a communication session between a requesting Java component in one namespace and the target Java component in another namespace via the communication channel, terminating the communication session if an error occurs in a Java component, and reestablishing the communication session.

### FIELD OF THE INVENTION

Embodiments of the invention relate generally to component-based applications, and more particularly to systems and methods of communication between Java components in different namespaces.

### BACKGROUND OF THE INVENTION

Advances in software development tools allow computer programs to be developed as component-based applications, which are applications that are dynamically formed at runtime using sets of distinct software elements known as components. Each of these components generally includes a set of certain tasks or operations known as methods that can be carried out by that component and may be invoked by other components. For example, components 11 may be locally or remotely stored in a repository 13, as illustrated in FIG. 1. When an application is required, the components 11 are dynamically loaded onto a computing device 1 and bound together to form an application 5 at runtime. During runtime, the components 11 may communicate with each other by invoking each other's methods to carry out the necessary tasks.

This capability provides flexibility in that functions can be added to the existing application 5 without recompiling the source code, and maintenance of the application 5 can be performed at runtime without shutting the application 5 down. For example, a defective component 7 may be replaced with a usable component 9 at runtime without shutting the application 5 down.

A software development tool that allows the development of component-based applications is Java, which is a programming language developed by Sun Microsystems, Inc., to generate applications that can run on all hardware platforms, small, medium, and large, without modification. Java is an interpreted language, meaning that the source code of a Java program is compiled into an intermediate language called “bytecode,” which must be interpreted into machine code at run time. Referring to FIG. 2, when a Java program 15 is launched within a computing device 1, a Java interpreter—referred to as a Java Virtual Machine (JVM) 19—translates the Java program bytecode 17 into machine code 21 that the processor 23 of the computing device 1 can recognize. In addition, the JVM 19 manages the operation of the bytecode 17, ensuring that it is safe to execute on the computing device and will not cause problems, i.e., will not behave as a computer virus.

Referring to FIG. 3, the more detailed features of a component-based Java program are illustrated. The Java program includes a component framework 25, which manages and provides an environment for the components 11. These components 11 may be specified by either a configuration file or a series of commands. The component framework 25 may be loaded onto a computing device 1 via a class loader. Class loaders, in general, are responsible for importing the bytecode defining the Java program and the corresponding components, and for ensuring that the components 11 are safe to operate on the computing device 1. There are two types of class loaders—a primordial class loader 24 and class loader objects 27. The primordial class loader 24 loads the trusted components, i.e., components which are known to be safe to operate, such as the classes of the Java API and the Java program component framework 25, and is part of the JVM 19 implementation. Class loader objects 27 are not. Class loader objects 27 are like any other Java objects, and are generally part of the Java program itself, loading components that are not necessarily trusted.

The component framework 25 uses the class loader objects 27 to load the Java program's necessary components 11, which may be obtained from the repository 13, into the component framework 25. Since these components 11 are loaded via the class loader objects 27, they may not be trustworthy, and thus, the class loader objects 27 load the components 11 into separate namespaces 26, i.e., separate operating regions within the computing device. With namespaces 26, the JVM 19, when managing the operation of the bytecodes, may group components 11 based on where they originate and allow them to operate simultaneously without interference from each other and without causing any problems on the computing device.

However, components 11 loaded into separate namespaces cannot directly communicate with each other, and often times it is desirable to allow them to do so. For example, component C in one namespace 26 may wish to obtain information residing in component B in a separate namespace 26, or component C in one namespace 26 may wish to invoke one of component A's methods in another namespace 26. One system that allows components in different namespaces to communicate with each other is InfoBus, which has been developed by Sun Microsystems, Inc. This system requires an additional Java interface to be implemented in every component that wishes to use InfoBus and also requires the Java abstract windowing toolkit (AWT) class to be installed on the computing device, which may add overhead. In addition, if components are using InfoBus for communicating with each other, InfoBus cannot reestablish the communication that ends as a result of an error. InfoBus further requires that the data exchanged between communicating components be tagged at runtime and that the components establish participation in the InfoBus with a specific role, i.e., producer, consumer, or both, before data can be exchanged, which limits communication flexibility.

### BRIEF DESCRIPTION OF THE DRAWINGS

A more particular description of the invention will be rendered by reference to specific embodiments thereof, which are illustrated in the accompanying drawings. Understanding that these drawings depict only typical embodiments of the invention and are not therefore to be considered limiting of its scope, embodiments of the invention will be described and explained with additional specificity and detail through the use of the accompanying drawings in which:

FIG. 1 is a block diagram of a conventional implementation of a Java program.

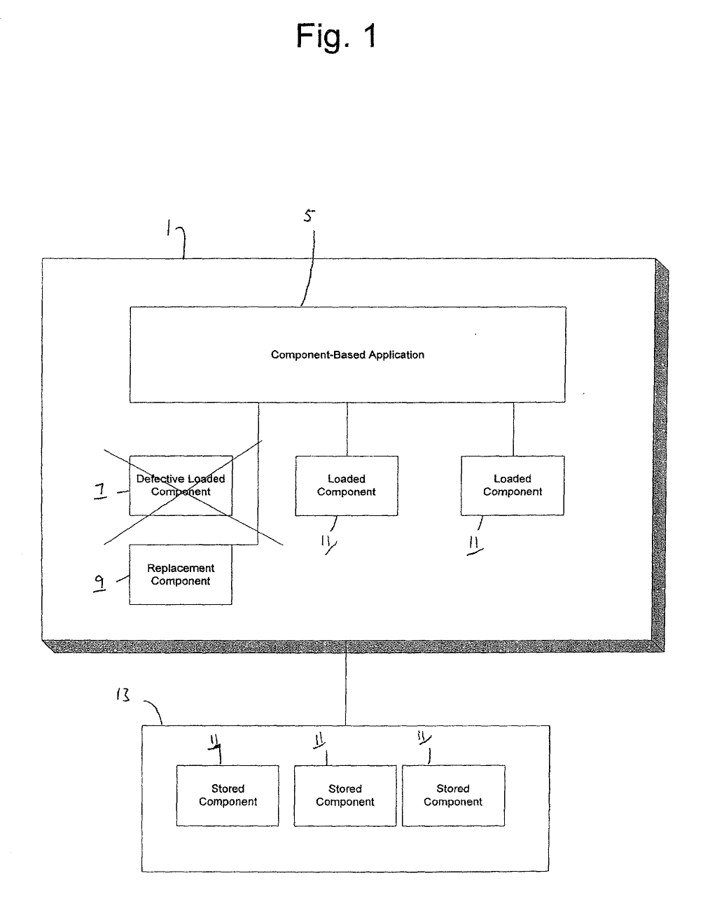

FIG. 2 is a flow diagram illustrating the operation of a conventional Java program.

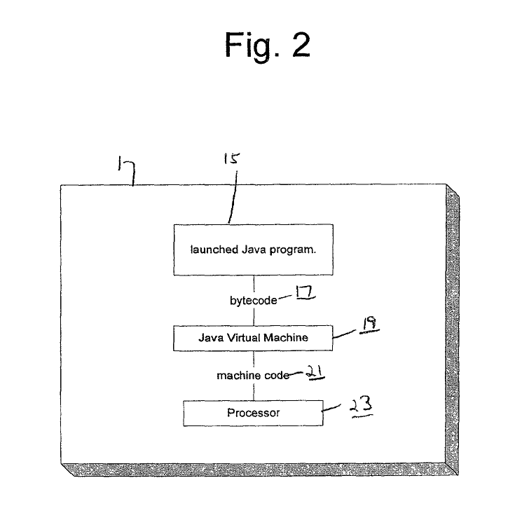

FIG. 3 is a block diagram of a conventional implementation of a component-based Java application.

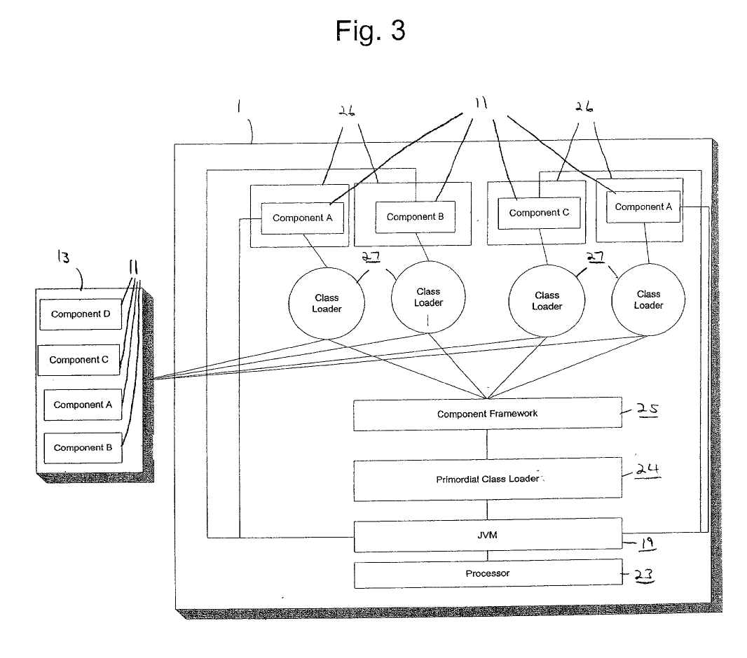

FIG. 4 is a block diagram of a component-based Java application constructed in accordance with an embodiment of the invention, wherein a single registered component and a single requesting component are particularly shown.

FIG. 5 is a block diagram of the embodiment in FIG. 4, wherein each module of the embodiment includes associated methods.

FIG. 6 is a block diagram of a an embodiment of a component-based Java application constructed in accordance with the invention, wherein multiple registered components and multiple requesting components are particularly shown.

FIG. 7(a) is a flow diagram of a method of registering a component within the component-based Java application of FIG. 4 performed in accordance with an embodiment of the invention.

FIG. 7(a) is a flow diagram of a method of de-registering a component within the component-based Java application of FIG. 4 performed in accordance with an embodiment of the invention.

FIG. 8(a) is a flow diagram of a method of establishing a communication session between components within the component-based Java application of FIG. 4 performed in accordance with an embodiment of the invention.

FIG. 8(b) is a flow diagram of a method of terminating a communication session between components within the component-based Java application of FIG. 4 performed in accordance with an embodiment of the invention.

FIG. 8(c) is a flow diagram of a method of reestablishing a communication session between components within the component-based Java application of FIG. 4 performed in accordance with an embodiment of the invention.

FIG. 9 is a flow diagram of a method of communication during a communication session between components within the component-based Java application of FIG. 4 performed in accordance with an embodiment of the invention, wherein a message is particularly shown being communicated through a communication channel.

### DETAILED DESCRIPTION

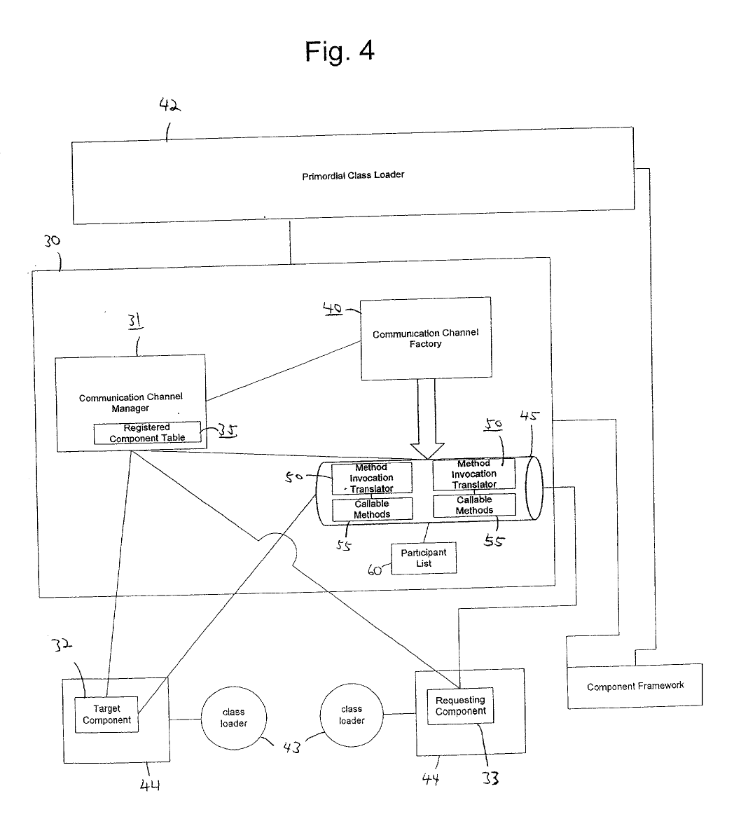

Referring now to FIG. 4, a Java component communication system 30 constructed in accordance with an embodiment of the invention is shown. The system 30 resides on a computing device, such as a computer, which includes one or more processors and/or memory (not shown), and may be included in an application and packaged into a Java JAR file for inclusion in the application. The system 30 generally allows components 32/33, which have been loaded in different namespaces 44 on the computing device by class loader objects 43, to indirectly communicate with one another. For the purposes of this application, the term “component”, when used in reference to software, is defined as a distinct software element that includes a set of methods, which may be invoked by other components. It is worth noting that the components 32/33, by virtue of their residence in the namespaces 44, do not directly communicate with each other, and thus, absent an interface, such as system 30, cannot communicate with each other. As will be described in further detail below, the system 30 is made up of several components (or modules) that are loaded onto the computing device by a primordial class loader 42, allowing the system 30 to gain access to, and communicate with the components 32/33.

The system 30 includes a component framework 41, which is configured to create an instance of the system 30 when the component framework 41 starts up. The system 30 further includes at least one communication channel (CC) 45, which is configured to provide communication sessions for the components 32/33, thereby allowing the components 32/33 to communicate with each other, e.g., by exchanging messages and invoking each other's methods. The CC 45 includes a list 60 (participant list) of all the components 32/33 participating in a communication session via the CC 45, and also has at least one method invocation translator (MIT) 50, having an associated callable methods table 55, associated with each participating component 32/33. The MIT's 50 within the CC 45 are configured to translate a message sent by one component 32 into a corresponding method invocation for its associated component 33, referring to the associated callable methods table 55 for the translation. The MIT's 50 are further configured to invoke the method and translate any return value from the method invocation into an equivalent return value usable by the component 32 that sent the message.

The system 30 further includes a communication channel factory (CCF) 40, which is configured to generate the CC's 45, and a communication channel manager (CCM) 31, which is configured to manage the communication system 30 by communicating with the CCF 40 and the CC's 45, and establishing, terminating, and reestablishing communication sessions between the components 32/33. The CCM 31 includes a registered component table (RCT) 35 with entries, or records, of components 32 in namespaces 44 registered with the CCM 31. The CCM 31 may register and de-register components 32/33, create CC's 45 via the CCF 40, destroy CC's 45, establish and terminate communication sessions between components 32/33 via a CC 45, and reestablish communication sessions that have been terminated.

The CC 45 may optionally be configured to deliver event notification to the participating components 32/33. These events indicate the state of the communication session in which the components 32/33 are participating. The CC 45 may deliver three types of events:

1. the establishment of a communication session;

2. the termination of a communication session; and

3. the reestablishment of a terminated communication session.

These events will be explained in further detail below, when the flow of operation is discussed.

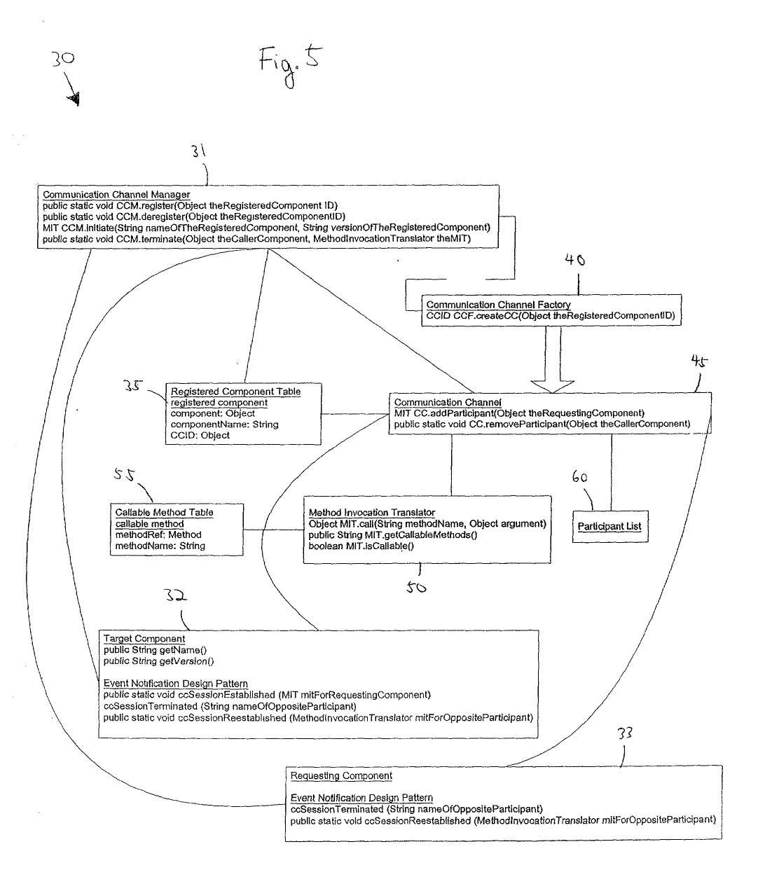

As illustrated in FIG. 5, each of the system 30 modules and each of the components 32/33 include a set of methods, which are invoked by other modules in the system 30 and/or components 32/33 in namespaces 44. These methods will be explained in further detail below, when the flow of operation is discussed.

In order for a communication session to be established between components 32/33 in different namespaces 44, the target component 32 must first register with the CCM 31, thereby making it available for a communication session with the component 33 when subsequently requested. Upon request by the registering component 32, the CCM 31 is configured to store a record identifying the target component 32 in the RCT 35, and the CCF 40 is configured to create an associated CC 45 for the target component 32. When another component (requesting component) 33 wishes to communicate with the target component 32, the requesting component 33 sends a message to the CCM 31 to request a communication session with the target component 32. In response to this message, CCM 31 is configured to search for the target component 32 in the RCT 35 and establish the requested communication session between the components 32/33 via the registered component's 32 associated CC 45.

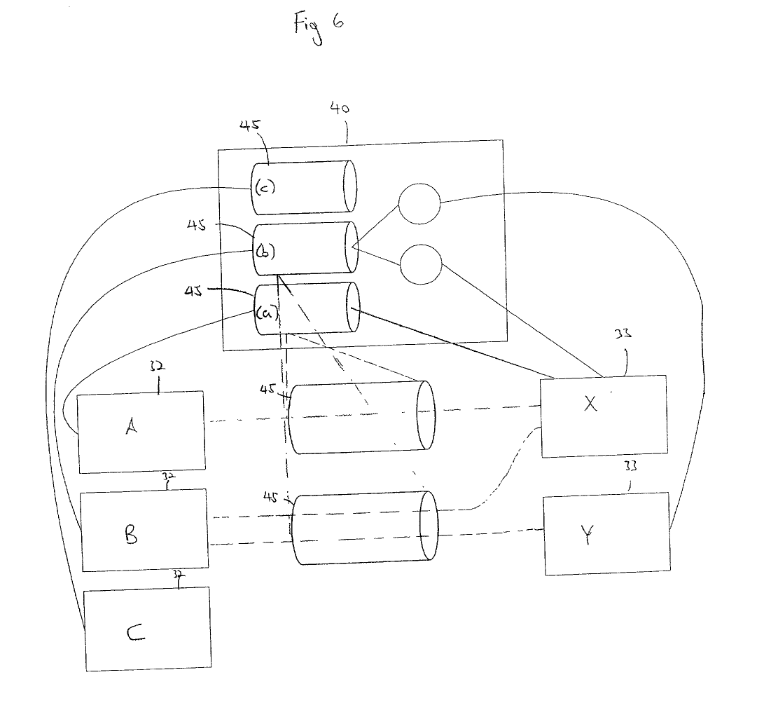

It should be noted that a requesting component 33 may initiate a communication session with more than one target component 32, and more than one requesting component 33 may initiate a communication session with a target component 32, as illustrated in FIG. 6. Specifically, a number of registered components 32 are each associated with a CC 45, created by the CCF 40. In this illustration, two requesting components, X and Y, have each established a communication session with registered component B through component B's associated CC 45 (b). By allowing components to share a CC 45, system resources are preserved. Additionally, requesting component X has also established a communication session with registered component A through component A's associated CC 45 (a). Although component C has been registered, and thus has an associated CC 45 (c), no communication session has been established for registered component C.

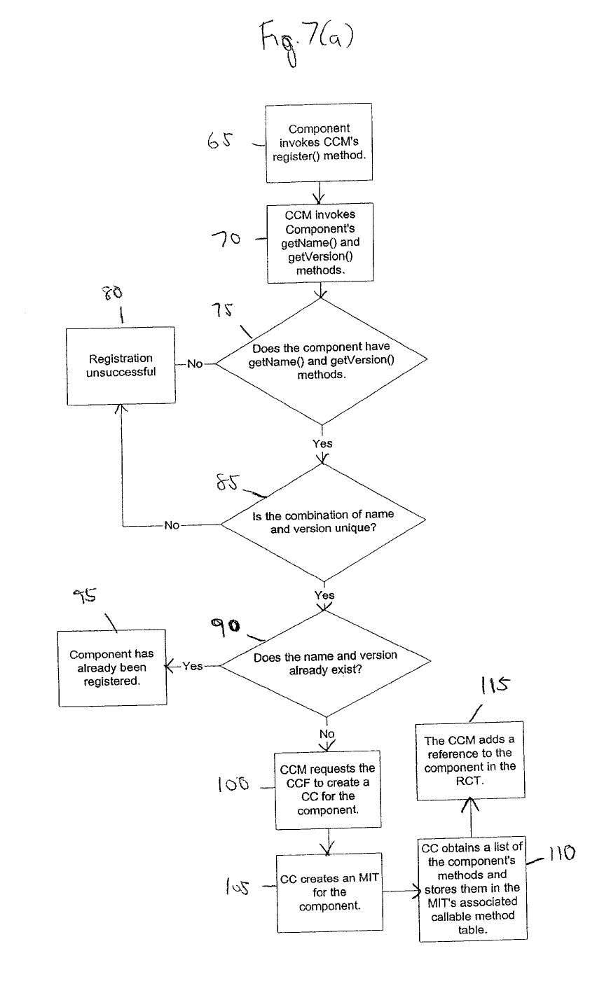

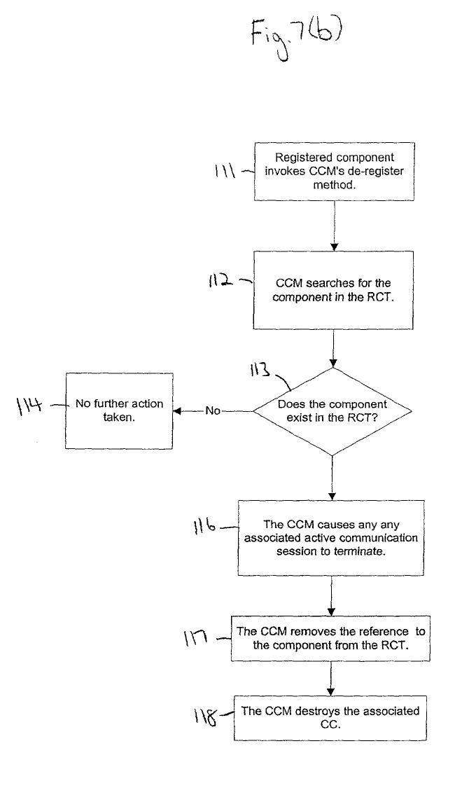

Turning to FIG. 7(a), the operation of the system 10 in registering the component 32 with the CCM 31 is illustrated. To initiate this process, the component 32 invokes a registering method of the CCM 31 (action block 65), which may be represented as:

public static void CCM.register (Object theRegisteredComponentID) (referred to in FIG. 5). This is a public static method, meaning that the method may be invoked by other components without having to create another CCM 31 object, and it has an argument of the type Object, theRegisteredComponentID. Each component 32 has an associated reference identification (ID), and when the component 32 invokes this method, it provides its own reference ID as an argument. Generally, the Java “this” reference may be used.

A component 32/33 that wishes to participate in the system 30 does not require the use of an inflexible Java interface, i.e., a rigid set of methods for sending and receiving messages. Instead, the component 32/33 uses a more flexible design pattern concept, which uses a set of rules that define how components communicate with one another without becoming entangled in each other's data models and methods. As can be appreciated by those with ordinary skill in the art, using design patterns in place of an inflexible interface provides for a more elegant and flexible method of communication.

To register with the CCM 31, the component 32 includes two methods that are performed in accordance with a design pattern:

public String getName( ); and

public String getVersion( ) (referred to in FIG. 5).

The method, getName( ), is configured to retrieve the component's 32 name as a Java string, and the method, getVersion( ), is configured to retrieve the component's version as a Java string. The combination of the name and version produces a unique sequence of characters that distinctly identifies the component from other components. The following example demonstrates how to implement the two methods:

public class SampleRegisteredComponent {

public String getName() { return name here }
public String getVersion() { return version here }
. . . Other component's specific methods

}

When the registering method is invoked, the CCM 31 invokes the getName( ) and getVersion( ) methods included in the component 32 described above, retrieving the name and version of the component (action block 70). If the required methods are not implemented (decision block 75) or if the combination of the name and version does not produce a unique sequence of characters (decision block 85), then the registration will be unsuccessful (resultant block 80). The CCM 31 then checks the RCT 35 for whether the name and version already exists (decision block 90). If so, then the component has already been registered (resultant block 95). If the name and version does not exist in the RCT 35, then the CCM 31 requests the CCF 40 to create for the target component 32, a CC 45 having an associated ID (action block 100) by invoking a method of CCF 40 that creates a CC 45, which may be represented as:

CCID CCF.createCC(Object theRegisteredComponentID) (referred to in FIG. 5). When invoking this method, the CCM 31 provides the argument, theRegisteredComponentID, which is the reference of the component that the CCM 31 is registering. The CCF 40 then creates the associated CC 45 and the corresponding ID as described above and returns the CCID to the CCM 31.

The CC 45 also creates an MIT 50 for the component 32 (decision block 105). Using a package known in the art, such as java.lang.reflect (Reflection) package, the CC 45 obtains a list of the component's 32 methods and stores them in the MIT's 50 associated callable method table 55 (action block 110). The CCM 31 subsequently makes an association between the target component 32 and the created CC 45 and places the association into the RCT 35 (action block 115). This sequence of characters, which are produced by the name and version of the component 32, coupled with the component's 32 ID is used as a key to identify the target component 32 in the RCT 35.

An entry or record in the table 35 may include the following fields (referred to in FIG. 5):

1. Java Object reference: the associated ID of the target component 32;

2. Java string: the sequence of characters produced from the name and version of the component 32; and

3. Java Object reference: the associated ID of the CC 45 created for the component 32.

It should be noted that not all of the components that wish to participate in the communication system 30 need to register itself with the CCM 31. Rather, only the components that wish to be available for communication with other components need to be registered.

Turning to FIG. 7(b), the operation of the system 30 in de-registering a registered component when the target component 32 no longer wishes to be available for communication, is illustrated. To initiate this process, the component 32 first calls a de-registering method of the CCM 31 (action block 111), which may be represented as:

public static void CCM.deregister(Object theRegisteredComponentID) (referred to in FIG. 5).

When the component 32 invokes this method, it passes a reference to itself, theRegisteredComponentID. The CCM 31 then checks for the existence of the component 31 from the RCT 35 (action block 112). If the component 32 is not found on the RCT 35 (decision block 113), no further processing is done (resultant block 114). If the component 32 is found, then the CCM 31 causes any associated active communication sessions to terminate (action block 116), removes the reference to the component from the RCT 35 (action block 117), and destroys, or alternatively, no longer refers to, the associated CC 45 (action block 118).

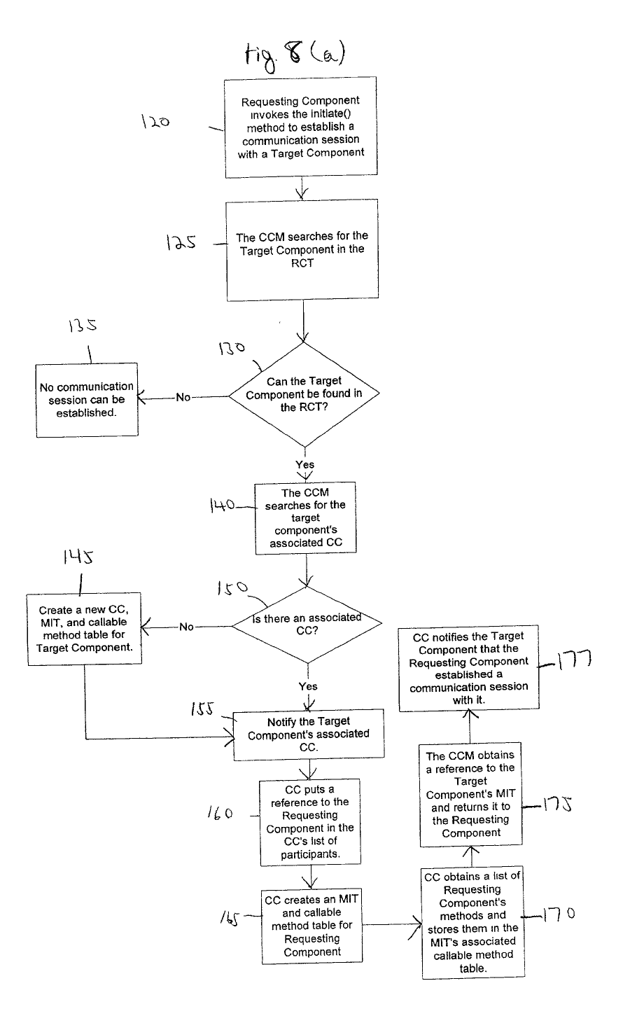

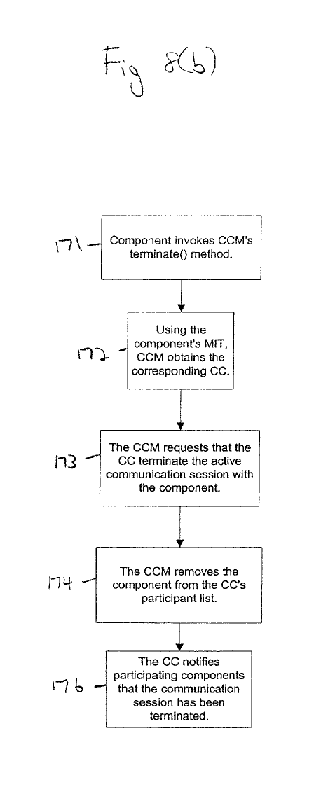

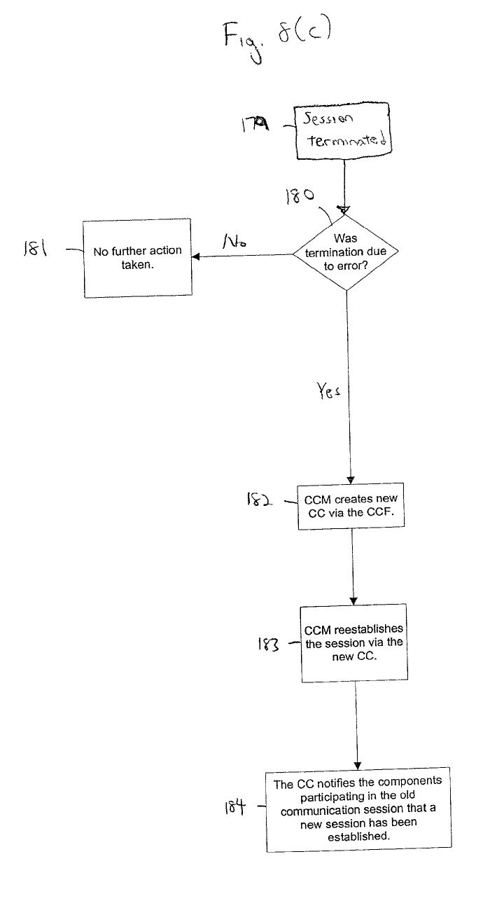

Turning to FIG. 8(a), the operation of the system 30 in establishing a communication session between the requesting component 33, which may or may not be registered, and the target component 32, which is registered, is shown. To initiate this process, the requesting component 33 makes a request to the CCM 31 by invoking an initiating method of the CCM 31 (action block 120), which may be represented as:

MIT CCM.initiate (String nameOfTheRegisteredComponent, String versionofTheRegisteredComponent) (referred to in FIG. 5).

When invoking this method, the requesting component 33 provides two String arguments, nameOfTheRegisteredComponent and versionOfTheRegisteredComponent, which are the name and version of the target component 32, respectively. When the method is invoked, the CCM 31 searches for the corresponding name and version on the RCT 35 (action block 125). If a corresponding name and version are not found (decision block 130), then the target component 32 does not exist or has not yet registered with the CCM 31, and no communication session can be established (resultant block 135). If the name and version are found (decision block 130), then the CCM 31 searches for the CC 45 associated with the corresponding target component 32 (action block 140). If there is no associated CC 45 (decision block 150), then the CCM 31 requests that the CCF 40 create one (action block 145). Regardless of whether an associated CC 45 exists at decision block 140, the CCM 31 will then notify the associated CC 45 of the requesting component (action block 155) by invoking a method of the CC 45 that adds a component as a participant, which may be represented as:

MIT CC.addParticipant(Object theRequestingComponent) (referred to in FIG. 5).

When invoking this method, the CCM 31 passes the reference of the requesting component as the argument, theRequestingComponent. The CC 45 adds the reference to the participant list 60 (action block 160) and creates an MIT 50 for the requesting component 33 (action block 165). Next, using the Reflection package, the CC 45 obtains a list of the requesting component's 33 methods and stores them in the MIT's 50 associated callable method table 55 (action block 170). The CC 45 then returns a reference to the target component's 32 MIT 50 to the CCM 31, which then returns it to the requesting component (action block 175).

The following sample code shows how a requesting component 33 initiates a communication session with a target component 32 with the name, “TargetComponentName”, and the version, “1.2.3.4”. The component would invoke the CCM's initiate ( ) method as follows:

MethodInvocationTranslater theMIT=null;

theMIT=CCM.initiate(“TargetComponentName”, “1.2.3.4”);

If the target component 32 is found in the RCT 35, then the reference to the target component's 32 MIT 50 will be returned to the variable, theMIT, in the requesting component. If the value of theMIT remains null, then the target component 32 was not found in the RCT 35 and the communication session was not established.

As mentioned above, the CC 45 may also be configured to deliver event notification to the participating components of the communication session 32/33. For target components 32, the CC 45 may deliver an event notifying that the target component 32 that a communication session has been established with it (action block 177). To receive this event, the target component 32 may also include a method, in accordance with a design pattern, which may be represented as:

public static void ccSessionEstablished (MIT mitForRequestingComponent) (referred to in FIG. 5).

The target component 32 may implement the session established event portion of the design pattern as follows:

public class SampleRegisteredComponent {

public void ccSessionEstablished(MethodInvocationTranslator
mitForRequestingComponent){ . . . }

}.

When a communication session has been established, the CC 45 will invoke this method, providing a reference to the requesting component's 33 MIT 50 as an argument. This method provides the target component 32 a reference to the requesting component's 33 MIT 50, which may be used to send messages and data to the requesting component 33, which will be described in more detail below. This allows for bi-directional communication, i.e., either component may send and receive messages during the communication session. Once the requesting component 33 has established a communication session with the target component 32, they may begin communicating with each other.

Turning to FIG. 8(b), the operation of the system 30 in terminating the communication session between the requesting component 33 and the target component 32 when a component 32/33 no longer wishes to participate in an active communication session, is illustrated. To initiate this process, that component 32/33 invokes a method of CCM 31 that terminates a communication session (action block 171), which may be represented as:

public static void CCM.terminate(Object theCallerComponent,

MethodInvocationTranslater theMIT) (referred to in FIG. 5). The method does not return any values. When the terminating component 32/33 invokes this method, the component passes two arguments, the component's own reference, theCallerComponent, and the reference to the component's MIT 50, theMIT. The CCM 31 uses the given MIT 50 to obtain the corresponding CC 45 (action block 172), requests the CC 45 to terminate the active communication session with the component (action block 173), and removes the terminating component 32/33 from the participant list 60 by invoking CC's 45 method that removes a participating component from the CC 45 (action block 174), which may be represented as:

public static void CC.removeParticipant(Object theCallerComponent) (referred to in FIG. 5).

When invoking this method, the CCM 31 provides the terminating component's 32/33 reference as an argument, theCallerComponent. Terminating a communication session does not necessarily terminate the CC 45, only the communication session specified by a participating component 32/33 requesting the termination.

When a communication session has been terminated, the CC 45 may deliver an event notification to the participating components 32/33 notifying them of the termination (action block 176). In order to receive the event, a component 32/33 participating in the communication session must include a method in accordance with a design pattern:

public void ccSessionTerminated (String nameOfOppositeParticipant) (referred to in FIG. 5).

The participating component 32/33 may implement the session terminated event portion of the design pattern as follows:

public class SampleParticipatingComponent {

public void ccSessionTerminated(String nameOfOppositeParticipant)
{ . . . }

}.

If the participating component is registered, then the design pattern would also include the session established event described above.

When the CC 45 invokes this method, the CC 45 passes the name of an opposite participant from the participant list 60 as an argument. If a component requested the communication session to be terminated, and the opposite component implemented the method, the CC 45 will invoke the method of the opposite component and terminate the corresponding communication session, but other communication sessions associated with the opposite component may still be operating. If the registered component de-registers itself from the system 30, i.e., invoke the CCM.deregister( ) method, then the CCM will cause existing communication sessions to terminate, as described above. The CCM 31 will then request the CC 45 to notify all the participating components that implemented the ccSessionTerminated( ) method that the communication session terminated.

Turning to FIG. 8(c), the operation of the system 30 in reestablishing the communication session between the requesting component 33 and the target component 32, is illustrated. This flow assumes that the communication session has first been terminated (action block 179). If the communication was terminated due to an occurrence other than an error (decision block 180), then no further action is taken (action block 181). If a communication session is terminated due to the occurrence of an error (decision block 180), then the communication system 30 creates a new CC 45 via the CCF (action block 182) and reestablishes the communication session via the new CC 45 (action block 183) to prevent the error from affecting the computing device's 1 system. In order for the communication session to be successfully reestablished, the new CC 45 preferably is able to deliver an event notification to the participating components 32/33 notifying them that the communication session has been reestablished (action block 184). In order to receive the event, the participating components 32/33 must include a method in accordance with a design pattern:

public static void ccSessionReestablished (MethodInvocationTranslater mitForOppositeParticipant) (referred to in FIG. 5).

The participating component 32/33 may implement the session reestablished event portion of the design pattern as follows:

public class SampleParticipatingComponent {

public void ccSessionReestablished(MethodInvocationTranslator
mitForOppositeParticipant){ . . . }

}.

If the participating component is registered, then the design pattern would also include the session established event and the session terminated event described above. If not, then the design pattern would include just the session terminated event.

When the CC 45 invokes this method, the CC 45 passes the reference to the MIT 50 of the opposite participating component for the participating component to use. Allowing the system 30 to reestablish a communication session that terminated due to an error provides for a highly reliable communication system 30 that is tolerant to failure.

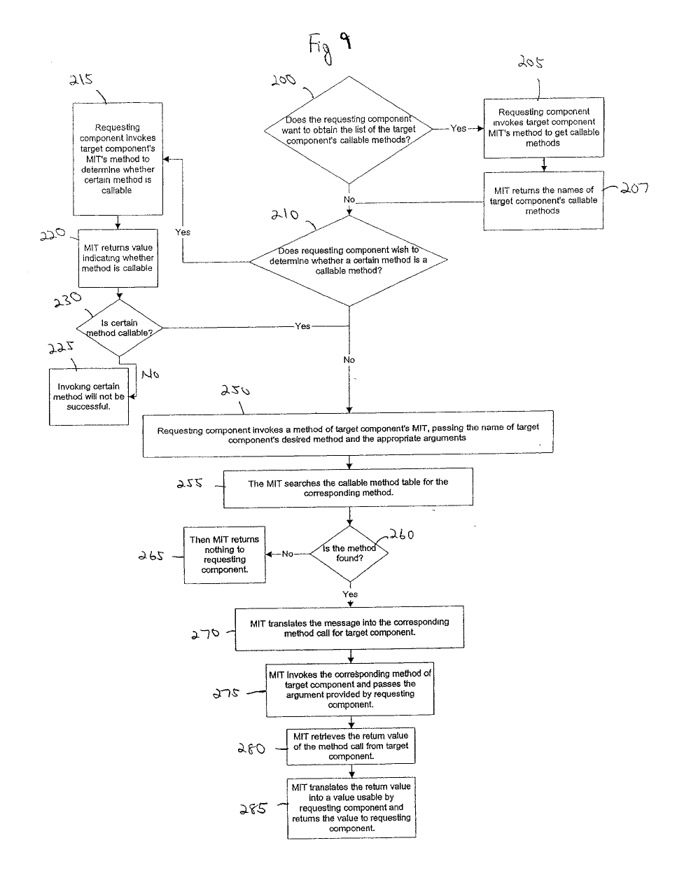

Referring further to FIG. 9, the operation of a system 30 when the requesting and target components 33 and 32 are participating in a communication session with each other via the target component's 32 associated CC 45 is illustrated. In this example, component 32, which is registered, contains a method “getTemperature”, which does not take any arguments. When invoked, getTemperature will return a temperature value.

If the requesting component 33 wishes to obtain the list of a target component's 32 callable methods (decision block 200), the requesting component 33 may invoke the target component's MIT's 50 method:

public String MIT.getCallableMethods( ) (referred to in FIG. 5) (action block 205).

This method will return the names of the target component's callable methods as a String (action block 207). If the requesting component 33 wishes to determine whether the target component's method, getTemperature, is callable or available (decision block 210), the requesting component 33 may invoke the target component's MIT's 50 method:

public boolean MIT.isCallable(String methodName) (referred to in FIG. 5) (action block 215).

When invoking this method, the requesting component 33 must pass the name of the applicable method as a String argument, i.e. “getTemperature”. The MIT 50 will return a Boolean value, i.e., binary based value, such as a 1 or 0 (action block 220). If the method is not callable or available (decision block 230), then the MIT will return a 0, notifying the requesting component 33 that it may not successfully invoke the method, getTemperature (resultant block 225). If the method is callable or available, then the MIT 50 will return a 1, and the requesting component 33 may successfully invoke the method.

When component 33 sends a message to component 32 to invoke getTemperature, component 33 invokes a method of component 32's MIT 50 (action block 250) that translates the message into a corresponding method call of component 32 and invokes that method call. The method of component 32's MIT 51 is represented as:

Object MIT.call (String methodName, Object argument) (referred to in FIG. 5).

When component 33 invokes the method, component 33 passes the name of component 32's desired method, getTemperature, as a string value for methodName and passes an Object containing any arguments that component 32's method may require, which is none in this example. The sample code may look like this:

Double temperature=MITforComponent32.call(“getTemperature”, null).

The MIT 50 for component 32 then searches the associated callable method table 55 for the method corresponding to “getTemperature” (action block 255) to determine whether the method exists within component 32 (decision block 260) (referring to FIG. 5, an entry in the callable method table 55 includes the name of a method, methodName, and a reference to the method, methodRef). If not found, then the MIT 51 for component 32 returns nothing to component 33 (action block 265). If found, then the MIT 51 for component 32 translates component 33's message into the corresponding method call for component 32:

Double Component32.getTemperature (NULL) (action block 270).

The MIT 51 for component 32 then invokes component 32's corresponding method, and passes the arguments provided by component 33, which is NULL (action block 275). The MIT 51 for component 32 then retrieves the return value from component 32 (action block 280), translates the value into a value usable by component 33, and returns it to component 33 (action block 285). In this case, the MIT 51 for component 32 returns a temperature value of the data type, double, to component 33, which places the value in a variable of data type double, temperature. The communication session is bi-directional, i.e., either component may send messages to an opposite component.

While embodiments of the invention have been shown and described, various modifications may be made without departing from the spirit and scope of the invention, and all such modifications and equivalents are intended to be covered.

What is claimed is:

1. A system, comprising:
a communication channel factory that generates a communication channel for a communication session; and
a communication channel manager that establishes the communication session between a request component and a target component, each component residing in different operating regions within a computing device, terminates the communication session and reestablishes the communication session.

2. The system of claim 1, wherein the components are Java components and the operating regions are namespaces.

3. The system of claim 1, wherein the communication channel manager terminates and reestablishes the communication session in response to an error.

4. The system of claim 1, wherein the communication channel comprises a method invocation translator that translates a message sent by one of the target component and request component into a method invocation for the other of the target component and request component.

5. The system of claim 1, wherein the communication channel comprises a method invocation translator that translates a message sent by the target component into a method invocation for the request component, and translates a message sent by the request component into a method invocation for the target component.

6. The system of claim 1, wherein the communication channel notifies the components when a communication session is established, terminated, and reestablished.

7. The system of claim 1, wherein the communication channel manager registers the target component.

8. A system, comprising:
a method invocation translator that translates a message received by a component residing in an operating region within a computing device into a method call of another component operating in a different region within the computing device and to invoke the corresponding callable method; and
a callable method table associated with the method invocation translator that stores the callable method of the other component.

9. The system of claim 8, wherein the components are Java components, and the operating regions are namespaces.

10. The system of claim 8, wherein the method invocation translator determines whether a method of a component is callable.

11. The system of claim 8, wherein the method invocation translator returns a value from the corresponding method call after the corresponding method call has been invoked.

12. A system, comprising:
a communication channel manager that registers a target component residing in an operating region within a computing device to make the target component available for communication with a requesting component residing in a different operating region within the computing device; and
a communication channel that provides the communication session.

13. The system in claim 12, wherein the components are Java components and the operating regions are namespaces.

14. The system in claim 12, further comprising a registered component table that stores a reference for the registered target component, and the communication channel manager searches the registered component table for the reference.

15. A method, comprising:
establishing a communication session between a requesting and a target component, each component residing in different operating regions within a computing device;
terminating the communication session; and
reestablishing the communication session.

16. The method of claim 15, wherein the components are Java components and the operating regions are namespaces.

17. The method of claim 15, wherein the termination and reestablishment of the communication session is performed in response to an error.

18. The method of claim 15, further comprising translating a message sent by one of the target component and requesting component into a method invocation for the other of the target component and requesting component.

19. The method of claim 15, further comprising:
translating a message sent by the target component into a method invocation for the requesting component; and
translating a message sent by the requesting component into a method invocation for the target component.

20. The method of claim 15, further comprising notifying the components when a communication session is established, terminated, and reestablished.

21. The method of claim 15, further comprising registering the target component to make the target component available for communication.

22. A method, comprising:
translating a message received by a component into a method call of another component, each component residing in different operating regions within a computing device and
invoking the corresponding method.

23. The method of claim 22, further comprising:
storing the corresponding method; and
retrieving the corresponding method when translating the message.

24. The method of claim 22, wherein the components are Java components, and the operating regions are namespaces.

25. The method of claim 22, further comprising determining whether a method of the one component is callable.

26. The method of claim 22, further comprising returning a value from the corresponding method after the corresponding method has been invoked.

27. A method, comprising:
registering a target component residing in an operating region within a computing device to make the component available for communication with a requesting component residing in different operating region within the computing device;
receiving a request from the requesting component to establish a communication session with the registered target component; and
establishing a communication session between the requesting component and the registered target component.

28. The method of claim 27, wherein the components are Java components and the operating regions are namespaces.

29. The method of claim 27, further comprising:
storing a reference for the registered target component; and
searching for the registered target component based on the reference.

30. A computer-readable medium comprising a sequence of instructions which, when executed by a processor, causes the processor to:
establish a communication session between a requesting component and a target components, each component residing in different operating regions within a computing device;
terminate the communication session; and
reestablish the communication session.

31. The computer readable medium of claim 30, wherein the components are Java components and the operating regions are namespaces.

32. The computer readable medium of claim 30, wherein the sequence of instructions which, when executed by a processor, cause the processor to terminate and reestablish the communication session, is executed in response to an error.

33. The computer readable medium of claim 30, further comprising a sequence of instructions which, when executed by a processor, cause the processor to translate a message sent by one of the target component and requesting component into a method invocation for the other of the target component and requesting component.

34. The computer readable medium of claim 30, further comprising a sequence of instructions which, when executed by a processor, cause the processor to:
translate a message sent by the target component into a method invocation for the requesting component; and
translate a message sent by the requesting component into a method invocation for the target component.

35. The computer readable medium of claim 30, further comprising a sequence of instructions which, when executed by a processor, cause the processor to notify the components when a communication session is established, terminated, and reestablished.

36. The computer readable medium of claim 30, further comprising a sequence of instructions which, when executed by a processor, cause the processor to register the target component to make the target component available for communication.

37. A computer readable medium comprising a sequence of instructions which, when executed by a processor, causes the processor to:
translate a message received by a component into a method call of another component, each component residing in different operating regions; and
invoke the corresponding method.

38. The computer readable medium of claim 37, further comprising a sequence of instructions which, when executed by a processor, causes the processor to:
store the corresponding method; and
retrieve the corresponding method when translating the message.

39. The computer readable medium of claim 37, wherein the components are Java components, and the operating regions are namespaces.

40. The computer readable medium of claim 37, further comprising a sequence of instructions which, when executed by a processor, causes the processor to determine whether a method of the one component is callable.

41. The computer readable medium of claim 37, further comprising a sequence of instructions which, when executed by a processor, causes the processor to return a value from the corresponding method after the corresponding method has been invoked.

42. A computer readable medium comprising a sequence of instructions which, when executed by a processor, causes the processor to:
register a target component residing in an operating region within a computing device to make the component available for communication with a requesting component residing in a different operating region within the computing device, including:
receive a request from the requesting component to establish a communication session with at the registered target component; and
establish a communication session between the requesting component and the registered target component.

43. The computer readable medium of claim 42, wherein the components are Java components and the operating regions are namespaces.

44. The computer readable medium of claim 42, further comprising a sequence of instructions which, when executed by a processor, causes the processor to:
store a reference for the registered target component; and
search for the registered target component based on the reference.
